(19) United States
(12) Patent Application Publication
(10) Pub. No.: US 2018/0250894 A1
(43) Pub. Date: Sep. 6, 2018

(54) IMPREGNATION TEST APPARATUS AND METHOD FOR EVALUATING IMPREGNATION PROPERTY USING THE SAME

(71) Applicants: Toho Chemical Engineering & Construction Co., Ltd., Shizuoka (JP); HONDA MOTOR CO., LTD., Tokyo (JP)

(72) Inventors: Masatoshi KOBAYASHI, Saitama (JP); Satoshi KIMURA, Shizuoka (JP)

(73) Assignees: Toho Chemical Engineering & Construction Co., Ltd., Shizuoka (JP); HONDA MOTOR CO., LTD., Tokyo (JP)

(21) Appl. No.: 15/911,712

(22) Filed: Mar. 5, 2018

(30) Foreign Application Priority Data
Mar. 6, 2017 (JP) 2017-041713

(51) Int. Cl. B29C 70/54; B29C 70/44; B29C 45/77; B29C 39/26

(52) U.S. Cl. CPC B29C 70/54; B29C 70/443; B29C 45/77; B29C 2945/76973; B29C 2945/76006; B29C 2945/76083; B29C 2945/76103; B29C 39/26

(57) ABSTRACT

An impregnation test apparatus includes: (1) a main body portion including a stage part having a recessed part in which an object to be impregnated is mounted, a bottom part of the recessed part provided with a plurality of through holes, an upper lid part mounted on the stage part, the upper lid part provided with a plurality of through holes in a parallel direction to the through holes, and a hollow part formed therein by mounting the upper lid part on the stage part,
(2) an impregnation liquid supply portion connected to the main body portion and supplying the impregnation liquid to the hollow part of the main body portion through the through hole formed in the stage part, and (3) a fixing mechanism fixing the object to be impregnated mounted on the stage part into the hollow part by mounting the upper lid part on the stage part.

### BACKGROUND

### Priority Claim

This application is a claims priority of Japanese Patent Application No. JP 2017-041713, filed Mar. 6, 2017, the entire content of which is incorporated herein by reference.

### Technical Field

The present invention relates to an impregnation test apparatus and a method for evaluating impregnation property using the same. More particularly, the present invention relates to an impregnation test apparatus for evaluating impregnation property in a thickness direction of a sheet-like object to be impregnated, and a method for evaluating impregnation property using the same.

### Related Art

A resin transfer molding (RTM) method is known as a method for molding a highly productive fiber reinforced composite material. The RTM method is a method for disposing a sheet-like fiber reinforced base material (object to be impregnated), such as a carbon fiber and a glass fiber in a molding die and clamping the molding die, supplying the resin to the molding die to impregnate the resin into the fiber reinforced base material, and then curing and molding the resin. The RTM method is expected as a method for manufacturing parts in large quantities by continuous production at a short cycle.

In order to manufacture a molded body of stable quality at the short cycle by the RTM method, it is required to increase an impregnation rate. For this purpose, it is necessary to define conditions, such as supply conditions of a resin, a thickness of a fiber bundle or specifications of fabrics of the object to be impregnated, and a laminating method, in advance by an experiment. However, evaluating the molded state by performing the experiment with large-scale RTM equipment (injection machine or mold) is time consuming and costly and is complicated. Therefore, a method for simply evaluating impregnation property of a resin in an object to be impregnated has been proposed.

JP-2016-203529 A and JP-2003-39451 A disclose an impregnation test apparatus for evaluating impregnation property in an in-plane direction (i.e., XY direction) of an object to be impregnated. However, when the object to be impregnated is laminated in the die in plural sheets and the like, there is a need to accurately evaluate not only the impregnation property in the in-plane direction (i.e., XY direction) of the object to be impregnated, but also the impregnation property in the thickness direction (Z direction) of the object to be impregnated. However, the evaluation method has not yet been established.

### SUMMARY

The conventional impregnation test apparatus evaluates only the impregnation property in the in-plane direction (XY direction) of the sheet-like object to be impregnated, but cannot evaluate the impregnation property in the thickness direction (Z direction) of the sheet-like object to be impregnated. For this reason, the impregnation property of the object to be impregnated could not be accurately evaluated by the conventional impregnation test apparatus alone.

An object of the present invention is to provide an impregnation test apparatus capable of accurately evaluating impregnation property in a thickness direction (Z direction) of a sheet-like object to be impregnated, and a method for evaluating impregnation property using the same.

The present inventors have conceived to supply an impregnation liquid in the thickness direction of the object to be impregnated to accurately evaluate the impregnation property in the thickness direction of the sheet-like object to be impregnated. When the impregnation liquid is supplied in the thickness direction, the object to be impregnated is partially deformed due to the flow of the impregnation liquid, and as a result the impregnation property may not be accurately evaluated. In particular, it has known that the tendency becomes more apparent when the sheet-like object to be impregnated is laminated in plural sheets. The present inventors have completed the present invention by conceiving a fixing mechanism which fixes the object to be impregnated into the impregnation test apparatus to suppress the shape of the object to be impregnated from being deformed.

A first aspect of the present invention is described in the following [1].

[1]

An impregnation test apparatus, including:
(1) a main body portion configured to include a stage part which has a recessed part in which an object to be impregnated is mounted, a bottom part of the recessed part being provided with a plurality of through holes and
an upper lid part which is mounted on the stage part, the upper lid part having a recessed part which has an opening part having the same shape as an opening part of the recessed part formed in the stage part and being provided with a plurality of through holes in a parallel direction to the through holes formed on the stage part when being mounted on the stage part, and
a hollow part formed therein by mounting the upper lid part on the stage part;
(2) an impregnation liquid supply portion configured to be connected to the main body portion and supply an impregnation liquid to the hollow part of the main body portion through the through hole formed in the stage part; and
(3) a fixing mechanism configured to fix the object to be impregnated mounted on the stage part into the hollow part by mounting the upper lid part on the stage part.

The invention described in the above [1] is the impregnation test apparatus for evaluating the impregnation property in the thickness direction (Z direction) of the sheet-like object to be impregnated. This impregnation test apparatus includes a main body portion and an impregnation liquid supply portion, and supplies the impregnation liquid from the impregnation liquid supply portion into the main body portion and evaluates the impregnation property of the impregnation liquid with respect to the object to be impregnated based on a flow rate, a pressure or the like of the impregnation liquid. The main body portion includes a stage part having a recessed part in which the sheet-like object to be impregnated is mounted, an upper lid part mounted on the stage part, and a fixing mechanism which fixes the object to be impregnated into a hollow part of the main body portion.

The first aspect of the present invention preferably includes components of the following [2] to [8].

[2]

The impregnation test apparatus according to [1], wherein porosity of the recessed part of the upper lid part is 1 to 80%.

According to the invention of the above [2], with respect to the area of the bottom part of the recessed part of the upper lid part, the opening area of the through hole formed on the bottom part of the recessed part of the upper lid part is within a predetermined range.

[3]

The impregnation test apparatus according to [1], wherein each hole diameter of the through holes formed in the recessed part of the upper lid part is 0.5 to 8 mm.

According to the invention of the above [3], the through hole having a predetermined hole diameter is formed in the upper lid part.

[4] The impregnation test apparatus described in the above [1], wherein the opened pattern of the through hole formed in the recessed part of the stage part is the same as the opened pattern of the through hole formed in the recessed part of the upper lid part.

According to the invention of the above [4], the opened pattern of the through hole formed in the recessed part of the stage part is the same as the opened pattern of the through hole formed in the recessed part of the upper lid part. In addition, when the upper lid part is mounted on the stage part, the through hole formed in the recessed part of the stage part and the through hole formed in the recessed part of the upper lid part have the same axis of the hole.

[5]

The impregnation test apparatus according to [1], wherein the fixing mechanism is an O-ring.

According to the invention of the above [5], the object to be impregnated is mounted on the stage part and then an O-ring is mounted on the outer edge part of the object to be impregnated, and the upper lid part is mounted on the stage part, so that the object to be impregnated is fixed in the hollow part of the main body portion. In other words, the outer edge part of the object to be impregnated is compressed by the O-ring, and the object to be impregnated is fixed in the hollow part formed between the stage part and the upper lid part.

[6]

The impregnation test apparatus according to [1], wherein the fixing mechanism is a combination of an O-ring and an intermediate packing.

According to the invention of the above [6], the plurality of sheet-like objects to be impregnated and the intermediate packing are alternately mounted, and the outer edge part of the object to be impregnated is compressed by the O-ring, so that the plurality of sheet-like objects to be impregnated are fixed in the hollow part formed between the stage part and the upper lid part.

[7]

The impregnation test apparatus according to [1], wherein a pressure measurement means is interposed between the main body portion and the impregnation liquid supply portion.

According to the invention of the above [7], the impregnation property of the impregnation liquid with respect to the object to be impregnated is evaluated based on the pressure of the impregnation liquid to be supplied.

[8]

The impregnation test apparatus according to [1], further including: an operator part correcting a thickness and the porosity of an object to be impregnated to a thickness and a porosity of the object to be impregnated at the time of a flow of the impregnation liquid.

A second aspect of the present invention is described in the following [9] and [10].

[9]

A method for evaluating impregnation property of an object to be impregnated using a permeability coefficient K which is calculated by the following Mathematical Formula (1) or (2),

[Mathematical Formula 1]

K=−Q/A×ϕ×μ×ΔL/ΔP (1)

K=−Q/A×μ×ΔL/ΔP (2)

based on a viscosity μ of an impregnation liquid, a flow rate Q of the impregnation liquid per unit time, an impregnation pressure P when the impregnation liquid flows in a thickness direction (Z direction) of the sheet-like object to be impregnated having an area A, porosity ϕ, and a thickness L, the method including:

(1) correcting the thickness L to a corrected thickness L1 which is an actual thickness in an impregnation apparatus before the flow of the impregnation liquid or a corrected thickness L2 which is an actual thickness of the object to be impregnated in the impregnation apparatus at the time of the flow of the impregnation liquid, or

(2) correcting the thickness L to a corrected thickness L1 which is an actual thickness in the impregnation apparatus before the flow of the impregnation liquid or a corrected thickness L2 which is an actual thickness of the object to be impregnated in the impregnation apparatus at the time of the flow of the impregnation liquid and

at the same time, correcting the porosity ϕ to actual porosity ϕ1 of the object to be impregnated in the impregnation apparatus before the flow of the impregnation liquid or corrected porosity ϕ2 which is actual porosity of the object to be impregnated in the impregnation apparatus at the time of the flow of the impregnation liquid.

[10]

A method for evaluating impregnation property of an object to be impregnated using the impregnation test apparatus according to any one of claims 1 to 8, including:

mounting a sheet-like object to be impregnated having an area A, porosity ϕ and a thickness L in a recessed part of a stage part to cover a through hole formed in the stage part and mounting an upper lid part on the stage part to fix and accommodate the object to be impregnated in a hollow part of a main body portion,

supplying an impregnation liquid having viscosity μ from an impregnation liquid supply portion to the object to be impregnated fixed to the main body portion through the through hole formed in the stage part of the main body portion, and calculating based on an impregnation pressure P of the impregnation liquid a corrected thickness L2 which is an actual thickness of the object to be impregnated in the impregnation apparatus at the time of the flow of the impregnation liquid or

the corrected thickness L2 which is the actual thickness and corrected porosity ϕ2 which is the actual porosity of the object to be impregnated in the impregnation apparatus at the time of the flow of the impregnation liquid,

evaluating the impregnation property of the object to be impregnated using a permeability coefficient K which is calculated by the following Mathematical Formula (3) or (4),

[Mathematical Formula 2]

K=−Q/A×ϕ2×μ×ΔL2/ΔP (3)

K=−Q/A×μ×ΔL2/ΔP (4)

based on a flow rate Q per unit time.

The invention described in the above [9] and [10] is the method for evaluating impregnation property in a thickness direction (Z direction) of a sheet-like object to be impregnated, and is the method for evaluating impregnation property which corrects the thickness L of the object to be impregnated and the porosity ϕ of the object to be impregnated to the actual thickness and porosity in the impregnation apparatus before the impregnation liquid flows or the thickness and the porosity in the state in which the impregnation liquid is actually flowing.

The impregnation test apparatus according to the present invention can evaluate the impregnation property in the thickness direction of the object to be impregnated. Since the object to be impregnated is fixed in the hollow part of the main body portion, the impregnation test apparatus can suppress the object to be impregnated from being deformed due to the flow of the impregnation liquid. For this reason, it is possible to accurately evaluate the impregnation property in the thickness direction of the object to be impregnated.

### BRIEF DESCRIPTION OF DRAWINGS

FIG. 1 is a schematic configuration diagram showing an example of an impregnation test apparatus of the present invention;

FIG. 2 is a cross-sectional view taken along line A-A′ of the main body portion in FIG. 1;

FIGS. 3A and 3B are plan views of a stage part and an upper lid part, respectively;

FIGS. 4A and 4B each are explanatory diagrams showing a state in which an object to be impregnated is mounted in a hollow part of a main body portion and mold-clamped;

FIG. 5 is a graph showing the relationship between a permeability coefficient and an impregnation pressure in Example 6 and Reference Example 2;

FIG. 6 is a graph showing the relationship between a permeability coefficient and porosity in Example 6 and Reference Example 2;

FIG. 7 is a graph showing the relationship between a permeability coefficient and porosity in Example 7 and Reference Example 3; and

FIG. 8 is a graph showing the relationship between a permeability coefficient and porosity in Example 8 and Reference Example 4.

### DETAILED DESCRIPTION

Hereinafter, an impregnation test apparatus of the present invention will be described below.

1. Structure of Impregnation Test Apparatus

The impregnation test apparatus of the present invention (hereinafter, also referred to as “impregnation test apparatus”) includes a main body portion whose hollow part accommodates an object to be impregnated, an impregnation liquid supply portion for supplying the impregnation liquid into the hollow part of the main body portion, and a fixing mechanism for fixing the object to be impregnated in the hollow part of the main body portion.

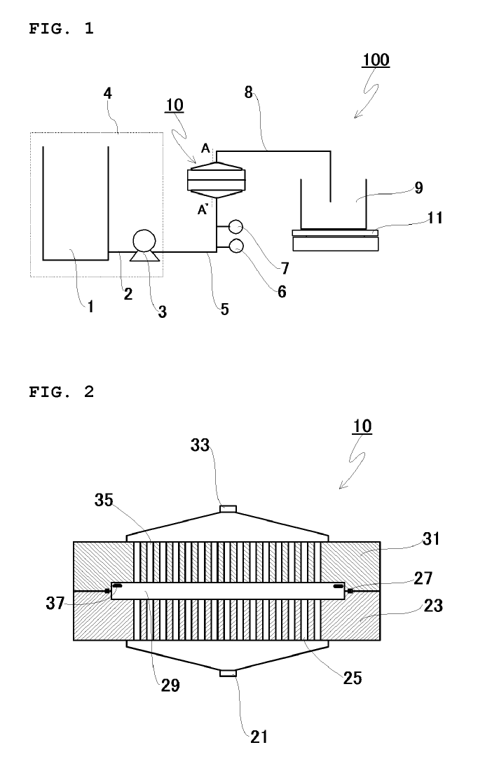

FIG. 1 is a schematic configuration diagram showing an example of the impregnation test apparatus. In FIG. 1, reference numeral 100 denotes the impregnation test apparatus, reference numeral 10 denotes a main body portion, and reference numeral 4 denotes the impregnation liquid supply portion. The impregnation liquid supply portion 4 is formed by connecting a liquid storage tank 1 to a pump 3 via a pipe 2. The impregnation liquid supply portion 4 is connected to the inlet side of the main body portion 10 via a pipe 5. A thermometer 6, and a pressure gauge 7 is interposed in the pipe 5. One end of a pipe 8 is connected to an outlet side of the main body portion 10, and the other end of the pipe 8 is open. The impregnation liquid discharged from the other end of the pipe 8 is configured to be recovered to a recovery tank 9. Reference numeral 11 denotes a balance, which is configured to be able to measure the mass (flow rate) of the impregnation liquid recovered to the recovery tank 9.

The liquid storage tank 1, the pipe 2, the pump 3, the pipe 5, the thermometer 6, the pressure gauge 7, the pipe 8, the recovery tank 9, and the balance 11 can all be configured by using known object. The thermometer 6, the pressure gauge 7, and the balance 11 may be configured to be able to output their output signals to a controller (not shown).

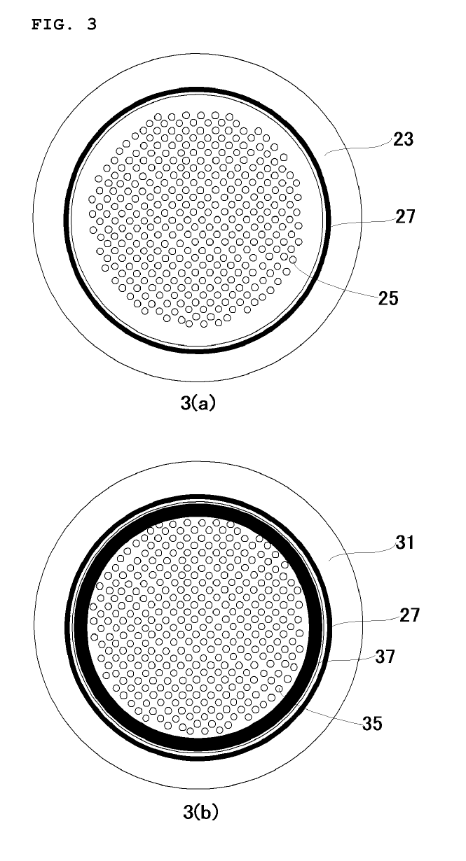

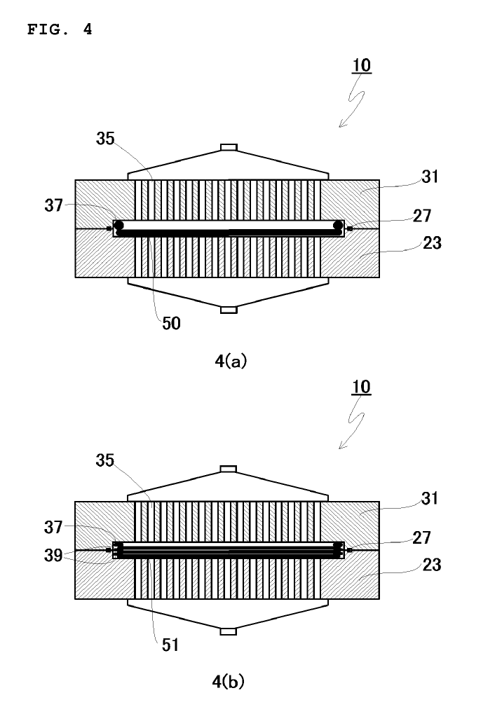

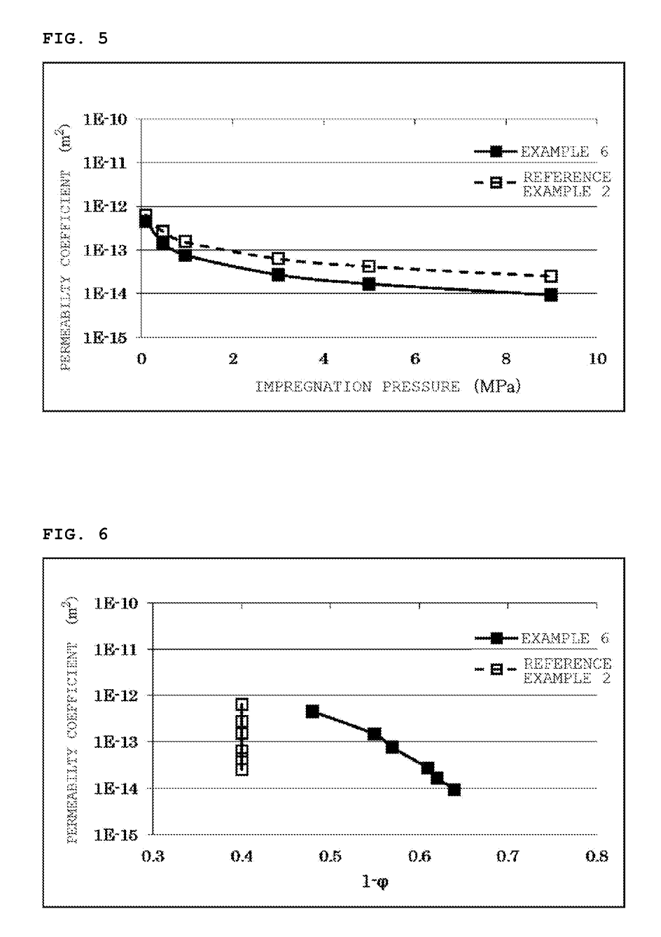

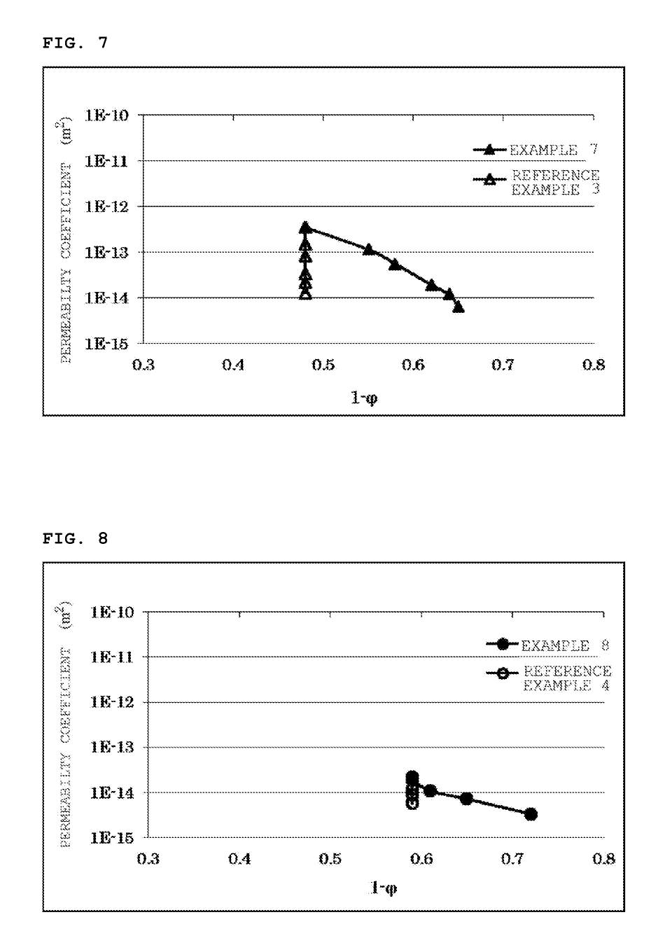

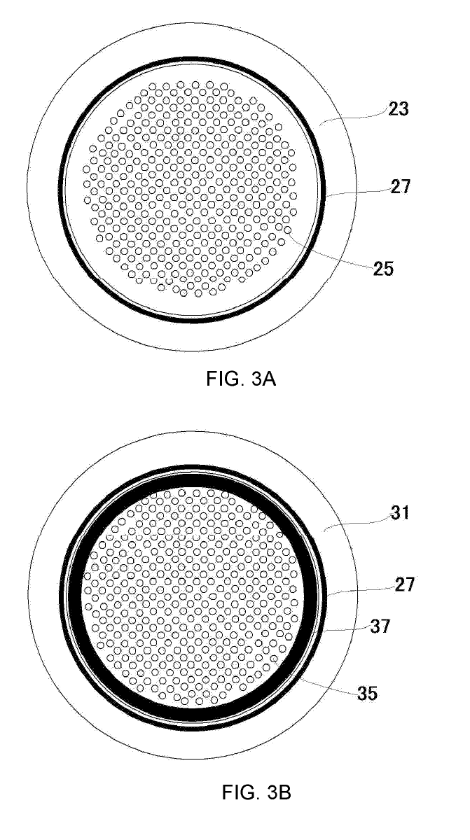

A sheet-like object to be impregnated is accommodated in an inside of the main body portion 10. The main body portion 10 is configured so that a flow direction of the impregnation liquid and a thickness direction (Z direction) of the sheet coincide with each other. FIG. 2 is a cross-sectional view showing a cross section of the main body portion 10 taken along line A-A′ in FIG. 1. FIG. 3A is a plan view of a stage part 23, and FIG. 3B is a plan view of an upper lid part 31. Reference numeral 23 denotes the stage part, which is provided with a recessed part in which the object to be impregnated is mounted. Reference numeral 31 denotes the upper lid part. The upper lid part is mounted on the stage part 23, so that a hollow part 29 is formed between the stage part 23 and the upper lid part 31. The upper lid part 31 has a recessed part which has an opening part having the same shape as an opening part of the recessed part formed in the stage part 23. An O-ring 27 is fitted between the stage part 23 and the upper lid part 31 to seal between the stage part 23 and the upper lid part 31 in a liquid-tight manner. A bottom part of the recessed part of the stage part 23 is provided with a through hole 25, and the upper lid part 31 is provided with a through hole 35 which has an axial center of the hole in a parallel direction to an axial center of the through hole 25. An impregnation liquid inlet 21 and an impregnation liquid outlet 33 are each formed below the stage part 23 and above the upper lid part 31. The impregnation liquid introduced from the impregnation liquid inlet 21 is supplied to the hollow part 29 through the through hole 25, and the impregnation liquid supplied to the hollow part 29 is drawn out from the impregnation liquid outlet 33 through the through hole 35. The fixing mechanism 37 (O-ring in FIG. 2) which fixes the object to be impregnated in the hollow part 29 by compressing an outer edge part of the object to be impregnated is disposed in the hollow part 29 of the main body portion 10.

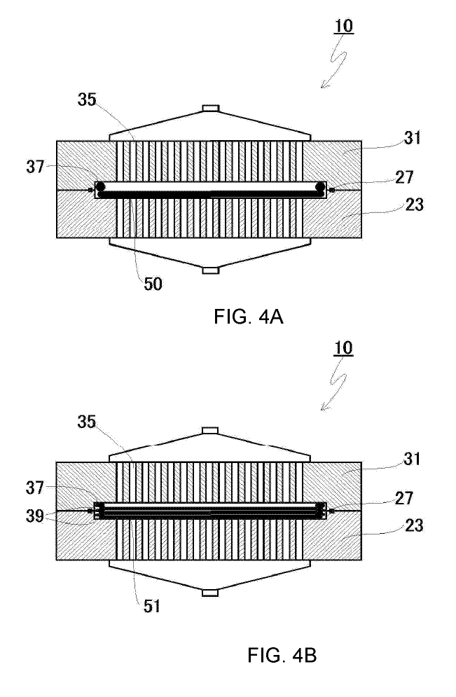

In the case of laminating the object to be impregnated in plural sheets, it is preferable to provide an intermediate packing 39 (see FIG. 4B) as a fixing mechanism in addition to the fixing mechanism 37. In the case of laminating the object to be impregnated in plural sheets, the intermediate packing 39 interposed between the objects to be impregnated to be able to suppress the object to be impregnated from being partially compressed and deformed (clogged) due to the flow of the impregnation liquid, thereby accurately evaluating the impregnation property.

A total opening area (i.e., opening ratio) of the through hole 25 formed on the bottom part of the recessed part of the stage part 23 with respect to an area of a bottom surface of the recessed part is preferably 1 to 80%, more preferably 5 to 60%. Similarly, a total opening area (i.e., opening ratio) of the through hole 35 formed on the bottom part of the recessed part of the upper lid part 31 with respect to the area of a bottom surface of the recessed part is preferably 1 to 80%, more preferably 5 to 60%. When the opening area is less than 1%, impregnation property in an in-plane direction comes to be evaluated, but impregnation property in a thickness direction cannot be evaluated accurately. The through hole 35 of the upper lid part 31 is preferably formed in the same manner as the through hole 25 of the stage part 23. That is, the through holes 25 and 35 each are preferably formed to have the same pattern (i.e., they are formed to have the same number, the same opening ratio, and the same opening diameter, and when the upper lid part 31 is mounted on the stage part 23, the through holes 25 and 35 each have the same axial center of the hole).

Although the shape of the opening part of the through hole 25 is not particularly limited, it is preferably circular. The plurality of through holes 25 are preferably formed at substantially equal intervals. The hole diameter of each of the through hole 25 and the through hole 35 preferably is 0.1 to 8 mm, more preferably 0.5 to 5 mm. When the hole diameter exceeds 8 mm, the shape of the object to be impregnated is likely to be partially deformed due to the flow of the impregnation liquid, and the reproducibility of the test may be lowered.

2. Method for Evaluating Impregnation Property

Next, a method for evaluating impregnation property of an object to be impregnated using the impregnation test apparatus is described.

First, the sheet-like object to be impregnated is mounted in the recessed part of the stage part 23. The shape of the object to be impregnated is a shape covering all the through holes formed in the recessed part of the stage part 23. Usually, the object to be impregnated is slightly smaller than the bottom surface of the recessed part of the stage part 23. Next, the fixing mechanism 37 is mounted on the object to be impregnated. Thereafter, the upper lid part 31 is mounted on the stage part 23, and is mold-clamped by a member (clamp, screw fastener and the like) not shown. As a result, the outer edge part of the object to be impregnated is compressed by the fixing mechanism 37, and the object to be impregnated is fixed in the hollow part 29 of the main body portion 10.

FIG. 4A is an explanatory diagram showing a state in which the object to be impregnated is mounted and clamped in the hollow part 29 of the main body portion 10. In FIG. 4A, reference numeral 50 denotes the object to be impregnated. The object to be impregnated is mounted in the recessed part of the stage part 23, and the outer edge part of the object to be impregnated is compressed by the fixing mechanism 37 so that the object to be impregnated is fixed in the hollow part 29 of the main body portion 10.

FIG. 4B is an explanatory diagram showing a state in which the plural sheets (3 sheets in FIG. 4B) of objects to be impregnated are mounted and clamped in the hollow part 29 of the main body portion 10. In FIG. 4B, reference numeral 51 denotes the object to be impregnated which is mounted in the recessed part of the stage part 23. The object to be impregnated 51 and the fixing mechanism (intermediate packing) 39 are alternately laminated, and the fixing mechanism 37 is mounted on the outer edge part of the top part thereof. As a result, the outer edge parts of each of the objects to be impregnated are compressed to be fixed in the hollow part 29 of the main body portion 10.

Next, the impregnation liquid is stored in the liquid storage tank 1 and the impregnation liquid is supplied to the main body portion 10 by using the pump 3. As a result, the impregnation liquid is impregnated which is accommodated in the hollow part 29 through the impregnation liquid inlet 21 and the through hole 25 of the main body portion 10. The impregnation liquid having passed through the object to be impregnated is drawn out to the outside of the main body portion 10 through the through hole 35 and the impregnation liquid outlet 33. The impregnation liquid drawn out from the main body portion 10 is recovered to the recovery tank 9 through the pipe 8.

At this time, the values of the pressure gauge 6, the thermometer 7, and the balance 11 are recorded, such that the impregnation property of the object to be impregnated is evaluated.

As the impregnation liquid, any liquid can be used, but usually water, silicone oil, a solution, a liquid resin or the like is used.

The object to be impregnated evaluated by the impregnation test apparatus is not particularly limited as long as it is a sheet form. Examples of the object to be impregnated may include fabric or nonwoven fabric of organic and inorganic fibers such as carbon fiber, glass fiber and aramid fiber, felt, mat and the like.

It is known that the flow of the resin inside a porous object to be impregnated such as the fabric or the nonwoven fabric of the carbon fiber follows the Darcy's law. That is, when a flow rate of resin transmitting the object to be impregnated per unit time is Q, an area of the object to be impregnated is A, a permeability coefficient is K, a porosity of the object to be impregnated is ϕ, a thickness of the object to be impregnated is L, an impregnation pressure is P, and a viscosity of resin is μ, the following Mathematical Formula (1) or (2) is satisfied.

[Mathematical Formula 3]

K=−Q/A×ϕ×μ×ΔL/ΔP (1)

K=−Q/A×μ×ΔL/ΔP (2)

Here, since the area A of the object to be impregnated, the porosity ϕ, the thickness L, and the viscosity μ of the resin are known, the permeability coefficient K is calculated by measuring the flow rate Q and the impregnation pressure P using the impregnation test apparatus, and as a result the evaluation can be made. Instead of the area A of the object to be impregnated, an opening area A′ (opening area of hole×number) may also be used. In this case, the purport shall be stated in the measurement conditions.

Here, as the thickness L and the porosity ϕ, the thickness L and the porosity ϕ before the object to be impregnated is impregnated can be used as they are. However, in order to perform the evaluation with higher precision, it is preferable to use a corrected thickness which is an actual thickness at the time of the impregnation of the impregnation liquid and corrected porosity which is actual porosity as the L and the ϕ. Here, there are a corrected thickness L1 and a corrected porosity ϕ1, a corrected thickness L2 and a corrected porosity ϕ2 as the corrected thickness and the corrected porosity.

In the impregnation test apparatus for compressing the object to be impregnated and accommodating the compressed object to be impregnated in the hollow part 29, it is preferable to use the corrected thickness L1 which is the compressed thickness in the impregnation apparatus and the thickness before the flow of the impregnation liquid and the corrected porosity ϕ1 which is the porosity compressed in the impregnation apparatus and the porosity before the flow of the impregnation liquid. Here, for a method for obtaining the corrected thickness L1 and the corrected porosity ϕ1, when the object to be impregnated is accommodated in the hollow part 29 while being compressed, a length in the thickness direction (parallel direction to the axis of the through hole) of the hollow part 29 can be set to be the corrected thickness L1, and the corrected porosity can be calculated from the degree of the compression. The impregnation test apparatus of the present invention preferably includes an operator part which calculates the corrected porosity ϕ1 from the degree of the compression of the object to be impregnated before the flow of the impregnation liquid.

In addition, in the present impregnation test apparatus for making the impregnation liquid flow in the thickness direction, if the impregnation pressure P is high, the object to be impregnated may be further compressed in the impregnation apparatus by the flow of the impregnation liquid. For this reason, the thickness L and the porosity ϕ of the object to be impregnated at the time of the flow of the impregnation liquid may be smaller than the corrected thickness L1 and the corrected porosity ϕ1. That is, if the impregnation pressure P exceeds a fastening pressure (filling pressure) of the object to be impregnated into the hollow part 29, there may be the case in which the precision of the evaluation cannot be sufficiently high even when the corrected thickness L1 and the corrected porosity ϕ1 are used. For this reason, it is more preferable to use the corrected thickness L2 which is the actual thickness at the time of flow of the impregnation liquid and the corrected porosity ϕ2 which is the actual porosity as the thickness L and the porosity ϕ. For a method for obtaining the corrected thickness L2 and the corrected porosity ϕ2, the compression test is performed on the object to be impregnated in advance to measure the relationship between the pressure and the thickness L and the porosity, thereby preparing a calibration curve. The corrected thickness L2 and the corrected porosity ϕ2 of the object to be impregnated at the time of the impregnation test can be obtained by the calibration curve, from the impregnation pressure value at the time of the impregnation test. It is preferable that the impregnation test apparatus of the present invention has the operator part which calculates the corrected thickness L2 and the corrected porosity ϕ2 using the calibration curve.

That is,

the method for evaluating impregnation property using the impregnation test apparatus of the present invention including

(1) mounting the sheet-like object to be impregnated having the area A, the porosity ϕ and the thickness L in the recessed part of the stage part to cover the through hole formed in the stage part and mounting the upper lid part on the stage part to fix and accommodate the object to be impregnated in the hollow part of the main body portion,

(2) supplying the impregnation liquid having the viscosity μ from the impregnation liquid supply portion to the object to be impregnated fixed to the main body portion through the through hole formed in the stage part of the main body portion, and

(3) using the permeability coefficient K calculated by the following Mathematical Formula (1) or (2),

[Mathematical Formula 4]

K=−Q/A×ϕ×μ×ΔL/ΔP (1)

K=−Q/A×μ×ΔL/ΔP (2)

based on the impregnation pressure P of the impregnation liquid and the flow rate Q per unit time to evaluate the impregnation property of the object to be impregnated, and

(4) the method for evaluating impregnation property using, as the thickness L and the porosity ϕ, the corrected thickness L1 which is the actual thickness before the flow of the impregnation liquid in the impregnation apparatus or the corrected thickness L2 which is the actual thickness at the time of the impregnation in the impregnation apparatus, and the corrected porosity ϕ1 which is the actual porosity before the impregnation in the impregnation apparatus or the corrected porosity ϕ2 which is the actual porosity at the time of the impregnation in the impregnation apparatus, is more preferable.

### EXAMPLES

Hereinafter, the present invention is described in more detail based on examples, but the present invention is not limited the following Examples.

### Example 1

Each of the diameters of the holes formed in the stage part and the upper lid part configuring the impregnation test apparatus shown in FIG. 1 was 3 mm, the number of holes was 19, and the opening ratio was 7%. The impregnation test apparatus evaluated the impregnation property by impregnating the object to be impregnated configured of 7 sheets of carbon fiber fabrics (biaxial non-crimp fabric (NCF) _0°/90°, total basis weight: 297 g/m²) with silicone oil (kinematic viscosity: 10 cSt). The results were as in the following Table 1. In a column of “state of object to be impregnated” in the following Table 1, “∘” means that the deformation of the object to be impregnated cannot be confirmed visually, “∘” means that the deformation of the object to be impregnated can be barely confirmed visually, and “x” means that the fact that the object to be impregnated is largely deformed can be confirmed visually.

### Examples 2 to 4, Comparative Examples 1 to 2

The evaluation was made in the same manner as in the above Example 1 except that the hole diameter, the number of holes and the opening ratio were changed as shown in the following Table 1. In Example 2, the through holes on the stage part and the upper lid part have the same shape and have the same axis of the hole. The results were as in the following Table 1.

TABLE 1

| | | The | | | | | | |
|---|---|---|---|---|---|---|---|---|
| | Hole | number | Opening | | | | | State of |
| | diameter | of | ratio | Pressure | Flow rate | Intermediate | | object to be |
| | (mm) | holes | (%) | (Mpa) | (g/sec) | packing | O-ring | impregnated |
| Example 1 | 3 | 19 | 7 | 10 | 7.4 | Absence | Presence | ⊙ |
| Example 2 | 3 | 121 | 43 | 8.6 | 11.7 | Absence | Presence | ⊙ |
| Example 3 | 5 | 19 | 19 | 6.1 | 13.1 | Absence | Presence | ◯ |
| Example 4 | 7 | 19 | 37 | 5.1 | 21.2 | Absence | Presence | ◯ |
| Example 5 | 3 | 121 | 43 | 8.7 | 8.6 | Presence | Presence | |
| Comparative | 10 | 19 | 76 | 5.4 | 25.1 | Absence | Presence | X |
| Example 1 | | | | | | | | |
| Comparative | 3 | 121 | 43 | Unstable | Unstable | Absence | Absence | |
| Example 2 | | | | | | | | |

### Example 5

The impregnation property was evaluated by impregnating the silicone oil (kinematic viscosity: 10 cSt) into the object to be impregnated obtained by laminating ten sheets of carbon fiber fabrics using the impregnation test apparatus of Example 2. Upon the lamination of the carbon fiber fabrics, the intermediate packing (thickness of 1 mm) was mounted every two sheets of carbon fiber fabrics. The impregnation property was evaluated by changing the impregnation pressure of the impregnation liquid by changing the flow rate of the pump and evaluating the relationship between the impregnation pressure and the flow rate of the impregnation liquid. As a result, the flow rate was 5.7 g/sec at a pressure of 0.5 MPa, the flow rate was 6.4 g/sec at a pressure of 1 MPa, the flow rate was 7.5 g/sec at a pressure of 3 MPa, the flow rate was 8.0 g/sec at a pressure of 5 MPa, a flow rate was 8.6 g/sec at a pressure of 8.7 MPa, and the pressure and the flow rate had the proportional relation. That is, it means that the partial deformation (clogging) of the carbon fiber fabric due to the flow of the impregnation liquid did not occur by using the intermediate packing and the impregnation liquid at the fabric edge part were not wrapped around.

### Reference Example 1

The impregnation property was evaluated by the same operation as in Example 5 except that the intermediate packing was not used. The evaluation of the impregnation property was repeated twice. As a result, in the first evaluation, a flow rate was 8.2 g/sec at a first pressure of 0.5 MPa and in the second evaluation, a flow rate was 9.3 g/sec at a pressure of 0.5 MPa, and both of the first and second evaluations had a larger flow rate than that in Example 5. In addition, when the flow rate was increased above the flow rate described above, the state in which the pressure was further unstable occurred. That is, it means that when the intermediate packing was not used, the carbon fiber fabric was partially deformed (clogged) due to the flow of the impregnation liquid, or there was a case in which the fluid at the fabric edge part was wrapped around, and the reproducibility of the test was degraded. On the other hand, the same results were obtained even when the evaluation of the impregnation property of Example 5 was repeatedly performed.

### Examples 6 to 8

To measure the relationship between the thickness L of the object to be impregnated and the compression stress, the compression test of the object to be impregnated was performed. As the reinforced fiber fabric, the sheets of carbon fiber fabrics (biaxial non-crimp fabric (NCF) 0°/90°, total basis weight of 297 g/m²) as shown in the following Table 2 were used. A test rate of a tester was 1 mm/min. The test was started from 22 mm which is a gap between upper and lower jigs which is sufficiently larger than the thickness L of the object to be impregnated. The object to be impregnated was compressed by lowering the upper jig and the thickness of the object to be impregnated with respect to the compressive stress was measured. The results are shown in the following Table 2.

TABLE 2

| | The | | | | | | | |
|---|---|---|---|---|---|---|---|---|
| | number | | | | | | | |
| | of lami- | Thickness (mm) of object to be impregnated | | | | | | |
| | nated | At non- | At | At | At | At | At | At |
| | sheet | com- | 0.1 | 0.5 | 1.0 | 3.0 | 5.0 | 9.0 |
| | (Sheet) | pression | MPa | MPa | MPa | MPa | MPa | MPa |
| Example 6 | 13 | 13.7 | 4.5 | 3.9 | 3.8 | 3.5 | 3.4 | 3.4 |
| Example 7 | 16 | 16.8 | 5.5 | 4.7 | 4.5 | 4.3 | 4.2 | 4.1 |
| Example 8 | 20 | 21.0 | 7.0 | 6.1 | 5.8 | 5.4 | 5.1 | 4.6 |

Next, the respective objects to be impregnated were accommodated in the main body portion of the apparatus of Example 1 and the impregnation liquid flowed. The evaluation of the impregnation property by the impregnation test apparatus was performed under the conditions that the injection pressure was 0.1 to 9.0 MPa, the flow rate was 1.7 to 6.3 cm³/sec in the case of Example 6, 1.1 to 3.7 cm³/sec in the case of Example 7, and 0.1 to 2.0 cm³/sec in the case of Example 8. The values used as the thickness of the object to be impregnated at the time of the impregnation were as shown in the following Table 3A, and the porosity were as shown in Table 3B. That is, in Examples 6 to 8, the values of the corrected thickness and the porosity were used. On the other hand, the values of the uncorrected thickness and porosity were used in Reference Examples 2 to 4. The permeability coefficient was calculated using the above Mathematical Formula (1) based on these values, and the results were as shown in FIGS. 5 to 8.

In the apparatus of Example 1, the distance from the bottom part of the recessed part in which the through hole of the stage part is formed to the bottom part of the recessed part in which the through hole of the upper lid part is formed is 5.6 mm. That is, if the object to be impregnated having the thickness exceeding 5.6 mm is accommodated and clamped in the main body portion, the maximum thickness of the object to be impregnated is compressed to 5.6 mm. For this reason, in Reference Examples 2 to 4, as the thickness of the object to be impregnated, 5.6 mm was used.

Referring to FIG. 5, if the impregnation pressure is increased, since the thickness and the porosity of the object to be impregnated at the time of impregnation become smaller, the actual permeability coefficient becomes smaller than that in the case of using the values of uncorrected thickness and porosity of the object to be impregnated.

Referring to FIGS. 6 to 8, in Examples 6 to 8, since the porosity of the object to be impregnated becomes smaller while the impregnation pressure is increased, the permeability coefficient becomes small as the impregnation pressure is increased. On the other hand, in Reference Examples 2 to 4, since the thickness and the porosity are not changed in response to the impregnation pressure, the relationship between the porosity and the permeability coefficient becomes constant.

### [Table 3]

TABLE 3A

| | The | | | | | | |
|---|---|---|---|---|---|---|---|
| | number of | | | | | | |
| | laminated | Thickness (mm) of object to be impregnated | | | | | |
| | sheet | At 0.1 | At 0.5 | At 1.0 | At 3.0 | At 5.0 | At 9.0 |
| | (Sheet) | Mpa | MPa | MPa | MPa | MPa | MPa |
| Example 6 | 13 | 4.5 | 3.9 | 3.8 | 3.5 | 3.4 | 3.4 |
| Example 7 | 16 | 5.5 | 4.8 | 4.5 | 4.3 | 4.2 | 4.1 |
| Example 8 | 20 | 5.6 | 5.6 | 5.6 | 5.4 | 5.1 | 4.6 |
| Reference | 13 | 5.6 | 5.6 | 5.6 | 5.6 | 5.6 | 5.6 |
| Example 2 | | | | | | | |
| Reference | 16 | 5.6 | 5.6 | 5.6 | 5.6 | 5.6 | 5.6 |
| Example 3 | | | | | | | |
| Reference | 20 | 5.6 | 5.6 | 5.6 | 5.6 | 5.6 | 5.6 |
| Example 4 | | | | | | | |

TABLE 3B

| | The | | | | | | |
|---|---|---|---|---|---|---|---|
| | number of | | | | | | |
| | laminated | Porosity of object to be impregnated | | | | | |
| | sheet | At 0.1 | At 0.5 | At 1.0 | At 3.0 | At 5.0 | At 9.0 |
| | (Sheet) | Mpa | MPa | MPa | MPa | MPa | MPa |
| Example 6 | 13 | 0.52 | 0.45 | 0.43 | 0.39 | 0.38 | 0.36 |
| Example 7 | 16 | 0.52 | 0.45 | 0.42 | 0.38 | 0.36 | 0.35 |
| Example 8 | 20 | 0.41 | 0.41 | 0.41 | 0.39 | 0.35 | 0.28 |
| Reference | 13 | 0.60 | 0.60 | 0.60 | 0.60 | 0.60 | 0.60 |
| Example 2 | | | | | | | |
| Reference | 16 | 0.52 | 0.52 | 0.52 | 0.52 | 0.52 | 0.52 |
| Example 3 | | | | | | | |
| Reference | 20 | 0.41 | 0.41 | 0.41 | 0.41 | 0.41 | 0.41 |
| Example 4 | | | | | | | |

Next, as a finite volume method, a three-dimensional impregnation flow/numerical simulation in which the above Mathematical Formula (2) was incorporated in the program was performed. The experiment used a transparent resin mold, and a mold cavity in which the object to be impregnated was disposed included an upstream part (width 200×depth 250×thickness 3.5 mm) and a downstream part (width 200×depth 250×thickness 7.0 mm) and had a shape in which the thickness is changed. The permeability coefficient in the thickness direction of the object to be impregnated adopted the respective values described in FIGS. 6 to 8 which were calculated using the corrected porosity ϕ1 and the corrected porosity ϕ2 and the permeability coefficients separately measured in the longitudinal direction and the vertical direction of the mold cavity were used. Although these simulation results showed substantially the same impregnation flow behavior up to the upstream part, the simulation using the permeability coefficient by the corrected porosity ϕ2 on the downstream side from the thickness change part in which the flow in the thickness direction occurs reproduced the impregnation flow behavior of the actual phenomenon satisfactorily. On the other hand, the simulation using the permeability coefficient by the corrected porosity ϕ1 had a large deviation from the actual phenomenon.

What is claimed is:

1. An impregnation test apparatus, comprising:
(1) a main body portion configured to include a stage part which has a recessed part in which an object to be impregnated is mounted, a bottom part of the recessed part being provided with a plurality of through holes and
an upper lid part which is mounted on the stage part, the upper lid part having a recessed part which has an opening part having the same shape as an opening part of the recessed part formed in the stage part and being provided with a plurality of through holes in a parallel direction to the through holes formed on the stage part when being mounted on the stage part, and
a hollow part formed therein by mounting the upper lid part on the stage part;
(2) an impregnation liquid supply portion configured to be connected to the main body portion and supply an impregnation liquid to the hollow part of the main body portion through the through hole formed in the stage part; and
(3) a fixing mechanism configured to fix the object to be impregnated mounted on the stage part into the hollow part by mounting the upper lid part on the stage part.

2. The impregnation test apparatus according to claim 1, wherein porosity of the recessed part of the upper lid part is 1 to 80%.

3. The impregnation test apparatus according to claim 1, wherein each hole diameter of the through holes formed in the recessed part of the upper lid part is 0.5 to 8 mm.

4. The impregnation test apparatus according to claim 1, wherein an opened pattern of the through hole formed in the recessed part of the stage part and an opened pattern of the through hole formed in the upper lid part are the same.

5. The impregnation test apparatus according to claim 1, wherein the fixing mechanism is an O-ring.

6. The impregnation test apparatus according to claim 1, wherein the fixing mechanism is a combination of an O-ring and an intermediate packing.

7. The impregnation test apparatus according to claim 1, wherein a pressure measurement means is interposed between the main body portion and the impregnation liquid supply portion.

8. The impregnation test apparatus according to claim 1, further comprising: an operator part correcting a thickness and the porosity of an object to be impregnated to a thickness and a porosity of the object to be impregnated at the time of a flow of the impregnation liquid.

9. A method for evaluating impregnation property of an object to be impregnated using a permeability coefficient K which is calculated by the following Mathematical Formula (1) or (2),
[Mathematical Formula 1]
K=−Q/A×ϕ×μ×ΔL/ΔP (1)
K=−Q/A×μ×ΔL/ΔP (2)
based on a viscosity μ of an impregnation liquid, a flow rate Q of the impregnation liquid per unit time, an impregnation pressure P when the impregnation liquid flows in a thickness direction (Z direction) of the sheet-like object to be impregnated having an area A, porosity ϕ, and a thickness L, the method comprising:
(1) correcting the thickness L to a corrected thickness L1 which is an actual thickness in an impregnation apparatus before the flow of the impregnation liquid or a corrected thickness L2 which is an actual thickness of the object to be impregnated in the impregnation apparatus at the time of the flow of the impregnation liquid, or
(2) correcting the thickness L to a corrected thickness L1 which is an actual thickness in the impregnation apparatus before the flow of the impregnation liquid or a corrected thickness L2 which is an actual thickness of the object to be impregnated in the impregnation apparatus at the time of the flow of the impregnation liquid and
at the same time, correcting the porosity ϕ to actual porosity ϕ1 of the object to be impregnated in the impregnation apparatus before the flow of the impregnation liquid or corrected porosity ϕ2 which is actual porosity of the object to be impregnated in the impregnation apparatus at the time of the flow of the impregnation liquid.

10. A method for evaluating impregnation property of an object to be impregnated using the impregnation test apparatus according to claim 1, comprising:
mounting a sheet-like object to be impregnated having an area A, porosity ϕ and a thickness L in a recessed part of a stage part to cover a through hole formed in the stage part and mounting an upper lid part on the stage part to fix and accommodate the object to be impregnated in a hollow part of a main body portion,
supplying an impregnation liquid having viscosity μ from an impregnation liquid supply portion to the object to be impregnated fixed to the main body portion through the through hole formed in the stage part of the main body portion, and calculating based on an impregnation pressure P of the impregnation liquid a corrected thickness L2 which is an actual thickness of the object to be impregnated in the impregnation apparatus at the time of the flow of the impregnation liquid or
the corrected thickness L2 which is the actual thickness and corrected porosity ϕ2 which is the actual porosity of the object to be impregnated in the impregnation apparatus at the time of the flow of the impregnation liquid,
evaluating the impregnation property of the object to be impregnated using a permeability coefficient K which is calculated by the following Mathematical Formula (3) or (4),
[Mathematical Formula 2]
K=−Q/A×ϕ2×μ×ΔL2/ΔP (3)
K=−Q/A×μ×ΔL2/ΔP (4)
based on a flow rate Q per unit time.
